(19) United States
(12) Patent Application Publication
(10) Pub. No.: US 2024/0143126 A1
(43) Pub. Date: May 2, 2024

(54) DISPLAY METHOD, APPARATUS, AND ELECTRONIC DEVICE

(71) Applicant: Beijing Zitiao Network Technology Co., Ltd., Beijing (CN)

(72) Inventors: Kexin Wang, Beijing (CN); Gan Lian, Beijing (CN)

(21) Appl. No.: 18/499,147

(22) Filed: Oct. 31, 2023

(30) Foreign Application Priority Data
Nov. 1, 2022 (CN) 202211358262.6
Dec. 14, 2022 (CN) 202211610810.X

(51) Int. Cl. G06F 3/04815; G06F 3/0482; G06F 3/04845

(52) U.S. Cl. CPC G06F 3/04815; G06F 3/0482; G06F 3/04845

(57) ABSTRACT

A display method, apparatus, and electronic device disclosed by the embodiments of the present disclosure, may display a two-dimensional thumbnail corresponding to a three-dimensional model on a human-computer interaction interface; in this way, computing resources and display resources required for viewing the three-dimensional model during a modeling process may be saved. After detecting a select operation for the displayed two-dimensional thumbnail, a solid frame may also be displayed at a display position of the selected two-dimensional thumbnail; and a display object corresponding to the selected two-dimensional thumbnail may be displayed within the solid frame.

### CROSS-REFERENCE TO RELATED APPLICATION(S)

This application claims priority to Chinese Application No. 202211358262.6 filed on Nov. 1, 2022, and Chinese Application No. 202211610810.X filed on Dec. 14, 2022, the disclosures of which are incorporated herein by reference in their entities.

### FIELD

The present disclosure relates to the technical field of Internet, and more specifically, to a display method, apparatus, and electronic device.

### BACKGROUND

With the development of science and technology, Virtual Reality (VR) technology has also been fully developed and has been widely used in film and television games (for example, VR videos, and VR games).

In the process of creating VR scenes, users usually need to select a specific model from the pre-established model library to create VR; and add the selected model to the corresponding location to create a three-dimensional model.

### SUMMARY

The summary of the present disclosure is provided to briefly introduce the concepts that are later described in detail in the Embodiments. The Summary of the present disclosure is not intended to identify key features or essential features of the claimed technical solution, nor is it intended to be used to limit the scope of the claimed technical solution.

Embodiments of the present disclosure provides a display method, apparatus, and electronic device, that displays a two-dimensional thumbnail corresponding to a three-dimensional model on a human-computer interaction interface; and when the two-dimensional thumbnail is selected, displays a solid frame at a display position of the two-dimensional thumbnail. Not only can the user be conveniently reminded that the two-dimensional thumbnail corresponds to the three-dimensional model, but the user can also be reminded which two-dimensional thumbnail the currently selected two-dimensional thumbnail is.

In accordance with a first aspect, one or more embodiments of the present disclosure provide a display method, comprising: displaying a two-dimensional thumbnail corresponding to a three-dimensional model on a human-computer interaction interface; and in response to detecting a select operation on a displayed two-dimensional thumbnail, displaying a solid frame at a display position of the selected two-dimensional thumbnail, and displaying a display object corresponding to the selected two-dimensional thumbnail within the solid frame.

In accordance with a second aspect, one or more embodiments of the present disclosure provide a display apparatus, comprising: a first display unit, configured to display a two-dimensional thumbnail corresponding to a three-dimensional model on a human-computer interaction interface; and a second display unit, configured to, in response to detecting a select operation on a displayed two-dimensional thumbnail, display a solid frame at a display position of the selected two-dimensional thumbnail, and display a display object corresponding to the selected two-dimensional thumbnail within the solid frame.

In accordance with a third aspect, one or more embodiments of the present disclosure provide an electronic device, comprising: one or more processors; and a memory, configured to store one or more programs, wherein, when the one or more programs are executed by the one or more processors, cause the one or more processors to implement the display method according to the first aspect.

In accordance with a fourth aspect, one or more embodiments of the present disclosure provide a non-transitory computer readable storage medium, with a computer program stored thereon, wherein when the program is executed by a processor, cause the processor to implement the display method according to the first aspect.

The display method, apparatus, and electronic device disclosed by the embodiments of the present disclosure, may display a two-dimensional thumbnail corresponding to a three-dimensional model on a human-computer interaction interface; in this way, computing resources and display resources required for viewing the three-dimensional model during a modeling process may be saved. After detecting a select operation for the displayed two-dimensional thumbnail, a solid frame may also be displayed at a display position of the selected two-dimensional thumbnail; and a display object corresponding to the selected two-dimensional thumbnail may be displayed within the solid frame. Such presentation approach not only facilitates the user to understand which two-dimensional thumbnail the currently selected two-dimensional thumbnail is, but also allows the user to understand that the two-dimensional thumbnail corresponds to a three-dimensional model.

Embodiments of the present disclosure further provide an implementation that is different from conventional technologies, The conventional technologies include dyeing objects in a display screen, a user needs to open a color palette, select a required target color from the color palette, change the brush color in the display screen to the target color, and then use the brush to dye the objects in the display screen. The dyeing method is relatively single and less flexible.

In accordance with a fifth aspect, the present disclosure provides a data processing method, comprising: displaying a first object in a scene; and upon determining that the first object triggers a second object in the scene, displaying the second object and/or a coloring object corresponding to the second object based on a mixed color, wherein the mixed color is determined based on a color corresponding to the first object and a color corresponding to the second object.

In accordance with a sixth aspect, the present disclosure provides a data processing apparatus, comprising: a display unit, configured to display a first object in a scene; and a determine unit, configured to determine that the first object triggers a second object. The display unit is further configured to, when the determine unit determines that that the first object triggers the second object in the scene, display the second object and/or a coloring object corresponding to the second object based on a mixed color, wherein the mixed color is determined based on a color corresponding to the first object and a color corresponding to the second object.

In accordance with a seventh aspect, the present disclosure provides an electronic device, comprising: a processor; and a memory, configured to store executable instructions for the processor, wherein the processor is configured to perform any method in the fifth aspect or various possible embodiments of the fifth aspect by executing the executable instructions.

In accordance with an eighth aspect, embodiments of the present disclosure provide a non-transitory computer readable storage medium with a computer program stored thereon, wherein when the computer program is executed by a processor, cause the processor to perform any method in the fifth aspect or various possible embodiments of the fifth aspect.

In accordance with a ninth aspect, embodiments of the present disclosure provide a computer program product, comprising: a computer program, wherein when the computer program is executed by a processor, cause the processor to perform any method in the fifth aspect or various possible embodiments of the fifth aspect.

The solution provided by the present disclosure that displaying a first object in a scene; and upon determining that the first object triggers a second object in the scene, displaying the second object and/or a coloring object corresponding to the second object based on a mixed color, wherein the mixed color is determined based on a color corresponding to the first object and a color corresponding to the second object, may flexibly select an object corresponding to a color, determine different mixed colors, and display a dyeing result based on the mixed color, that is, the second object and/or the coloring object corresponding to the second object, thereby effectively improving the flexibility of the dyeing method for dyeing objects in the display screen.

### BRIEF DESCRIPTION OF THE DRAWINGS

The above and other features, advantages, and aspects of various embodiments of the present disclosure will become more apparent with reference to the following embodiments in combination with the drawings. Throughout the drawings, the same or similar reference numbers refer to the same or similar elements. It is to be understood that the drawings are schematic and that components and elements are not necessarily drawn to scale.

FIG. 1 is a flowchart of one or more embodiments of a display method according to the present disclosure.

FIG. 2A-FIG. 2B are display schematic diagrams of a human-computer interaction interface of another embodiment of the display method according to the present disclosure.

FIG. 2C-FIG. 2D are display schematic diagrams of a human-computer interaction interface of another embodiment of the display method according to the present disclosure.

FIG. 3 is a display schematic diagram of a three-dimensional model displayed in a virtual space of another embodiment of the display method according to the present disclosure.

FIG. 4 is a structural schematic diagram of one or more embodiments of a display apparatus according to the present disclosure.

FIG. 5 is an exemplary system architecture in which a display method according to one or more embodiments of the present disclosure may be applied.

FIG. 6 is a schematic diagram of a basic structure of an electronic device according to one or more embodiments of the present disclosure.

FIG. 7 is a structural schematic diagram of a system provided by an exemplary embodiment of the present disclosure.

FIG. 8 is a schematic flowchart of a data processing method provided by an exemplary embodiment of the present disclosure.

FIG. 9 is a schematic diagram of a color combination and its corresponding mixed first color provided by an exemplary embodiment of the present disclosure.

FIG. 10 is a schematic diagram of controlling and changing a beam direction of a coloring object corresponding to a first object provided by an exemplary embodiment of the present disclosure.

FIG. 11 is a schematic diagram of a scene provided by an exemplary embodiment of the present disclosure.

FIG. 12 is structural schematic diagram of a data processing apparatus provided by an exemplary embodiment of the present disclosure.

FIG. 13 is a structural schematic diagram of an electronic device provided by one or more embodiments of the present disclosure.

### DETAILED DESCRIPTION OF EMBODIMENTS

Embodiments of the present disclosure will be described in more detail below with reference to the drawings. Although certain embodiments of the disclosure are shown in the drawings, it should be understood that the disclosure may be embodied in various forms and should not be construed as limited to the embodiments set forth herein. Rather, these embodiments are provided so that the present disclosure will be thorough and complete.

It should be understood that the drawings and embodiments of the present disclosure are for illustrative purposes only and are not intended to limit the scope of the present disclosure.

It should be understood that, various steps described in the method embodiments of the present disclosure may be executed in different orders and/or in parallel. Furthermore, the method embodiments may include additional steps and/or omit performance of illustrated steps. The scope of the present disclosure is not limited in this regard.

As used herein, the term “include” and its variations are open-ended, that is, “including but not limited to.” The term “based on” means “based at least in part on.” The term “one embodiment” means “at least one embodiment”; the term “another embodiment” means “at least one additional embodiment”; and the term “some embodiments” means “at least some embodiments”. Relevant definitions of other terms will be given in the description below.

It should be noted that, concepts such as “first” and “second” mentioned in the present disclosure are only used to distinguish different apparatuses, modules or units, and are not used to limit the order or interdependence of the functions performed by these apparatuses, modules or units.

It should be noted that, the modifications of “one” and “a plurality of” mentioned in the present disclosure are illustrative and not restrictive. Those skilled in the art will understand that unless the context clearly indicates otherwise, it should be understood as “one or more”.

The names of messages or information exchanged between multiple apparatus in the embodiments of the present disclosure are for illustrative purposes only and are not used to limit the scope of these messages or information.

Some terms used in the embodiments of the present disclosure are explained below to facilitate understanding by those skilled in the art.

Global Positioning System (GPS): is a high-precision radio navigation positioning system based on artificial earth satellites; and may provide accurate geographical location, vehicle speed and precise time information anywhere in the world and in near-Earth space.

Simultaneous Localization and Mapping (SLAM): is first proposed in the field of robotics, and refers to: the robot starts from an unknown location in an unknown environment, locates its own position and posture through repeatedly observed environmental features during movement, and then builds an incremental map of the surrounding environment based on its own position, thereby achieving the purpose of simultaneous positioning and map construction.

Virtual Reality (VR), the basic implementation method of which is based on computer technology, using the latest development results of various high technologies, with the help of computers and other devices, to generate a virtual world with realistic three-dimensional vision, touch, smell and other sensory experiences, thereby giving people in the virtual world an immersive feeling.

Augmented Reality (AR) technology is a technology that cleverly integrates virtual information with the real world, which has extensively used a variety of technical means such as multimedia, three-dimensional modeling, real-time tracking and registration, intelligent interaction, and sensing to simulate computer-generated text, images, three-dimensional models, music, videos and other virtual information, and then applied it to the real world, wherein the two types of information complement each other to achieve “enhancement” of the real world.

Mixed Reality (MR) technology is a further development of virtual reality technology, which introduces real scene information into the virtual environment and sets up an interactive feedback information loop among the virtual world, the real world and the user to enhance the realism of the user experience.

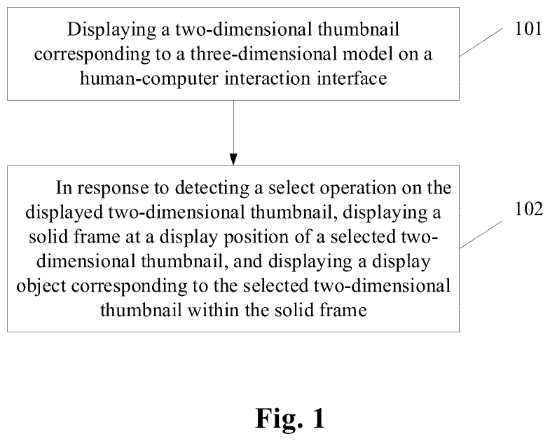

Refer to FIG. 1, which shows a flow of one embodiment of a display method according to the present disclosure. The display method may be applied to terminal devices. As shown in FIG. 1, the display method includes the following steps:

Step 101: Displaying a two-dimensional thumbnail corresponding to a three-dimensional model on a human-computer interaction interface.

As an example, during VR modeling, the human-computer interaction interface may be displayed in a target virtual space. The target virtual space may be understood as the virtual space required for VR modeling, or it can be understood as the virtual space where a VR model is located when the VR model is built.

As an example, the two-dimensional thumbnail corresponding to the three-dimensional model may be displayed on the human-computer interaction interface. In some embodiments, the human-computer interaction interface may also be simply a sticker (that is, the two-dimensional thumbnail).

Meanwhile, since less computing resources and display resources are required to display two-dimensional thumbnails, the computing resources required during a VR modeling process may be saved.

As an example, the human-computer interaction interface within the target virtual space may be understood as an interface for displaying the two-dimensional thumbnail. The specific presentation form of the human-computer interaction interface may be set according to the actual situation.

Step 102: In response to detecting a select operation on the displayed two-dimensional thumbnail, displaying a solid frame at a display position of a selected two-dimensional thumbnail, and displaying a display object corresponding to the selected two-dimensional thumbnail within the solid frame.

Here, the display object corresponding to the two-dimensional thumbnail may be a two-dimensional thumbnail, or a three-dimensional model corresponding to the two-dimensional thumbnail, or a reduced or enlarged image corresponding to the two-dimensional thumbnail. That is, displaying the display object corresponding to the selected two-dimensional thumbnail in the solid frame may represent that a current user has selected that two-dimensional thumbnail, or it can be understood that the user has selected the three-dimensional object corresponding to that two-dimensional thumbnail. The two-dimensional thumbnail may indicate that it lacks certain solid information relative to the three-dimensional model, and the plane projection area of a certain three-dimensional model may be greater than, less than, or equal to the area of its corresponding two-dimensional thumbnail.

As an example, the select operation may be understood as a select operation on a two dimensional thumbnail. Of course, a specific type of the selected operation may be set according to the actual situation, and the specific type of the select operation is not limited here. For example, a pointing cursor may be displayed in the target virtual space. When the pointing cursor is moved to a certain two-dimensional thumbnail, it may indicate that a select operation has been performed on that two-dimensional thumbnail. For another example, a virtual hand may also be displayed in the target virtual space. The virtual hand may emit rays, and the two-dimensional thumbnails emitted by the rays may be understood as the selected thumbnails.

As an example, displaying a solid frame at a position where a two-dimensional thumbnail is selected may facilitate the user to determine which two-dimensional thumbnail the currently selected two-dimensional thumbnail is, and may prompt the user that the two-dimensional thumbnail corresponds to a three-dimensional model.

As an example, the color of the solid frame may be limited according to actual conditions, as long as it is easy for users to identify.

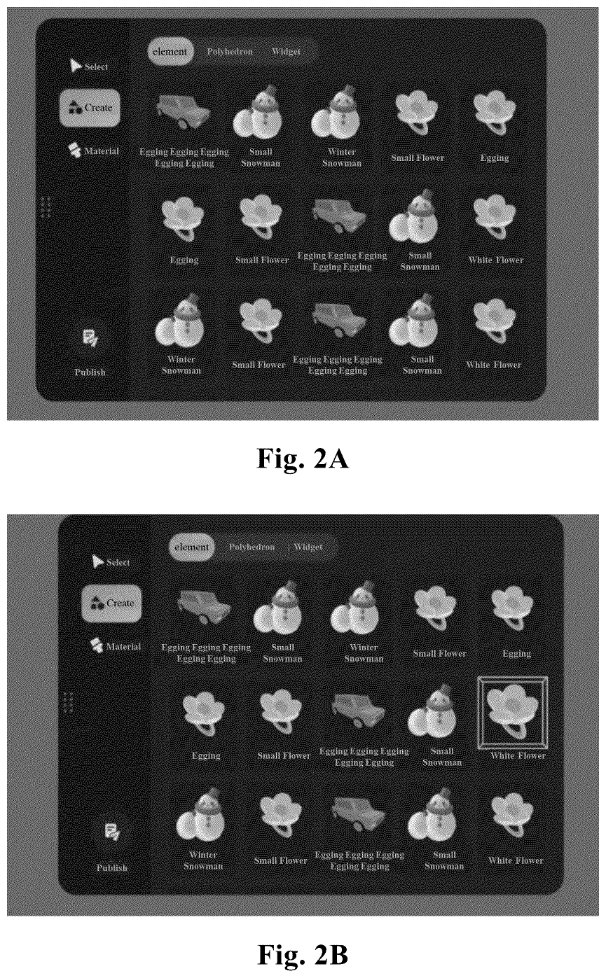

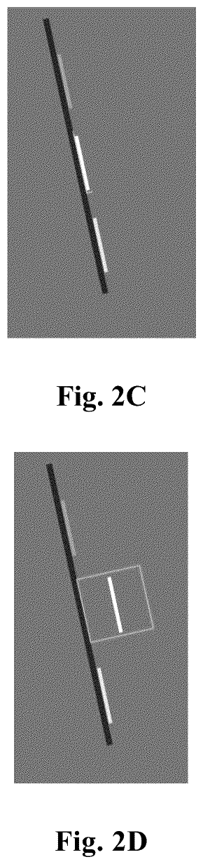

In order to understand the concept of the present disclosure, an example is provided by taking the display object corresponding to the selected two-dimensional thumbnail as the selected two-dimensional thumbnail. In order to facilitate better understanding, the description may be made in conjunction with FIG. 2A-FIG. 2B. Both FIG. 2A and FIG. 2B may be understood as the display schematic diagram of a human-computer interaction interface displaying two-dimensional thumbnails. As can be seen from FIG. 2A, the human-computer interaction interface may display at least one two-dimensional thumbnail. And it can be seen from FIG. 2B that, after a select operation is performed on a certain two-dimensional thumbnail, the solid frame may be displayed at the display position of the selected two-dimensional thumbnail (FIG. 2B may be understood as the user has selected the two-dimensional thumbnail of the last ‘white flower’ in the second row of the human-computer interaction interface. In this case, the two-dimensional thumbnail is displayed in the solid frame).

In order to further understand the schematic diagram when the display object corresponding to the selected two-dimensional thumbnail is displayed in the solid frame, the explanation may be continued in conjunction with FIG. 2C-FIG. 2D. FIG. 2C may be understood as a side view of a two-dimensional thumbnail displayed on a human-computer interaction interface, and FIG. 2D may be understood as a side view of a display object corresponding to a selected two-dimensional thumbnail and displayed in a solid frame. As can be seen from FIG. 2D, the display object corresponding to the selected two-dimensional thumbnail can be displayed in the solid frame.

In related technologies, during the modeling process, a three-dimensional model that may be selected by the user is usually directly presented at the human-computer interaction interface in the target virtual space; however, since all three-dimensional models are presented in this way, a large amount of computing resources and display resources will be consumed.

In the present disclosure, the two-dimensional thumbnail corresponding to the three-dimensional model may be displayed on the human-computer interaction interface. In this way, computing resources and display resources required for viewing the three-dimensional model during a modeling process may be saved. After detecting a select operation for the displayed two-dimensional thumbnail, a solid frame may also be displayed at the display position of the selected two-dimensional thumbnail; and a display object corresponding to the selected two-dimensional thumbnail may be displayed within the solid frame. Such presentation approach not only facilitates the user to understand which two-dimensional thumbnail the currently selected two-dimensional thumbnail is, but also allows the user to understand that the two-dimensional thumbnail corresponds to a three-dimensional model.

In some embodiments, the display object includes a selected two-dimensional thumbnail and/or a sub three-dimensional model.

Here, the sub three-dimensional model indicates the selected three-dimensional model, and the selected three-dimensional model corresponds to the selected two-dimensional thumbnail.

Here, the sub three-dimensional model may be understood as a reduced version of the model corresponding to the selected three-dimensional model. That is, the shape of the sub three-dimensional model may be the same as the shape of the selected three-dimensional model, but the size of the sub three-dimensional model may be smaller than the size of the selected three-dimensional model. It can be understood that the size of the sub three-dimensional model may also be greater than or equal to the size of the selected three-dimensional model.

As an example, displaying the sub three-dimensional model in the solid frame not only allows the user to understand the specific shape of the selected three-dimensional model corresponding to the selected two-dimensional thumbnail, and conduct a three-dimensional preview in real time, but also let the user know which specific three-dimensional model the selected two-dimensional thumbnail corresponds to more conveniently. In this way, the sub three-dimensional model is only loaded when the user selects a certain model, which may save the display resources and computing resources required by the user during the display process.

In some embodiments, the display object may also be the selected two-dimensional thumbnail. In this way, by changing the display position of the two-dimensional thumbnail only, the user may know which specific two-dimensional thumbnail is currently selected and the three-dimensional model corresponding to the selected two-dimensional thumbnail. Thus, the display resources and computing resources required by the user during the display process may be saved.

In some embodiments, the display object includes the selected two-dimensional thumbnail. At this time, in step 103, displaying the solid frame at the display position of the selected two-dimensional thumbnail, and displaying the display object corresponding to the selected two-dimensional thumbnail within the solid frame may specifically include: moving the selected two-dimensional thumbnail from an original position into the solid frame in a predefined manner.

As an example, the original position of the selected two-dimensional thumbnail may be understood as the position where the selected two-dimensional thumbnail is displayed on the human-computer interaction interface.

As an example, the predefined manner may be set according to the actual situation, which may, for example, directly jump from the original position to the solid frame for display, or slowly move from the original position to the solid frame for display.

Here, moving the selected two-dimensional thumbnail from an original position into the solid frame in a predefined manner means changing the display position of the selected two-dimensional thumbnail, so that the selected two-dimensional thumbnail displayed in the human-computer interaction interface is more different from other two-dimensional thumbnails. That is, when the selected two-dimensional thumbnail is moved into the solid frame, the selected two-dimensional thumbnail may be made more protruded compared to other two-dimensional thumbnails. Further, a combination of the moved two-dimensional thumbnail and the solid frame has a more three-dimensional visual effect, which may better attract the user's attention and make it easier for the user to know which two-dimensional thumbnail is currently selected; meanwhile, the three-dimensional model corresponding to the two-dimensional thumbnail may also be learned based on the displayed solid frame.

In some embodiments, the above-mentioned moving the selected two-dimensional thumbnail from an original position into the solid frame in a predefined manner may specifically comprises: moving the selected two-dimensional thumbnail from the original position into the solid frame along a direction indicated by a first normal vector.

Here, the first normal vector is a normal vector of the human-computer interaction interface.

As an example, moving the selected two-dimensional thumbnail along the first normal vector may keep the selected two-dimensional thumbnail parallel to the human-computer interaction interface during the movement process, thereby improving the user's browsing experience.

In some embodiments, when the selected two-dimensional thumbnail is displayed in the solid frame, the selected two-dimensional thumbnail is parallel to the human-computer interaction interface.

As an example, the selected two-dimensional thumbnail is parallel to the human-computer interaction interface. In this way, when the selected two-dimensional thumbnail is able to be moved into the solid frame, the perspective from which the user views the selected two-dimensional thumbnail will not be changed, which may further improve the user's browsing experience.

In some embodiments, the selected two-dimensional thumbnail may also be moved from the original position to the above-mentioned solid frame at a constant speed.

As an example, in a process of moving the selected two-dimensional thumbnail to the solid frame at a constant speed, the user's visual experience is better.

In some embodiments, the selected two-dimensional thumbnail may also be moved from the original position to the above-mentioned solid frame in parallel and at a constant speed. In this way, during the position transformation process, the selected two-dimensional thumbnail may be changed evenly, so that the user will have a better visual experience.

In some embodiments, the selected two-dimensional thumbnail is coplanar with the center of the solid frame.

As an example, moving the selected two-dimensional thumbnail to the center of the solid frame may prevent the solid frame from blocking the selected two-dimensional thumbnail; and because the selected two-dimensional thumbnail is parallel to the human-computer interaction interface, the display angle of the selected two-dimensional thumbnail is the same as that of other two-dimensional thumbnails, while the selected two-dimensional thumbnail is more protruded than other two-dimensional thumbnails. In this way, when the user browses the selected two-dimensional thumbnail, the user's browsing experience is better because the combination of the two-dimensional thumbnail and the solid frame has a more three-dimensional visual effect.

In some embodiments, the three-dimensional model may correspond to a bounding box. At this time, based on a first shape information of the bounding box corresponding to the selected three-dimensional model, a second shape information of the solid frame may be determined.

Here, the selected two-dimensional thumbnail may correspond to the selected three-dimensional model.

As an example, the shape of the bounding box corresponding to the selected three-dimensional model may be consistent with the shape of the solid frame. In this way, the user may be better prompted that the two-dimensional thumbnail has a corresponding three-dimensional model.

In some embodiments, the shape of the bounding box may be set according to the actual situation. For example, the shape of the bounding box may be a solid shape, such as a sphere or a cone.

In some embodiments, the shape of the two-dimensional thumbnail may be a rectangle, and the shape of the solid frame may be a cuboid. A first side of the solid frame may also be in contact with the human-computer interaction interface.

As an example, the first side of the solid frame is in contact with the human-computer interaction interface, so that when the selected two-dimensional thumbnail is moved into the solid frame, the selected two-dimensional thumbnail will not be moved to other spaces, thereby making the effect of moving the selected two-dimensional thumbnail better.

In some embodiments, the human-computer interaction interface is displayed in a target virtual space; and the target virtual space may further display a movable predefined three-dimensional object. Here, the movable predefined three-dimensional object is configured to move the selected three-dimensional model according to a move operation by a user. At this time, in response to detecting a select instruction for the selected two-dimensional thumbnail, the selected three-dimensional model may be displayed at a first end of the movable predefined three-dimensional object.

As an example, the select instruction may be understood as orienting the first end of the movable predefined three-dimensional object toward the two-dimensional thumbnail. That is, when the first end of the movable predefined three-dimensional object is directed toward a certain two-dimensional thumbnail, it may represent that a select instruction has been performed on the two-dimensional thumbnail.

As an example, after a select instruction is performed on a certain two-dimensional thumbnail, the three-dimensional model corresponding to the two-dimensional thumbnail may be displayed at the first end of the movable predefined three-dimensional object. In this way, it is convenient for the user to better view the three-dimensional model, as well as positioning the three-dimensional model to achieve VR modeling.

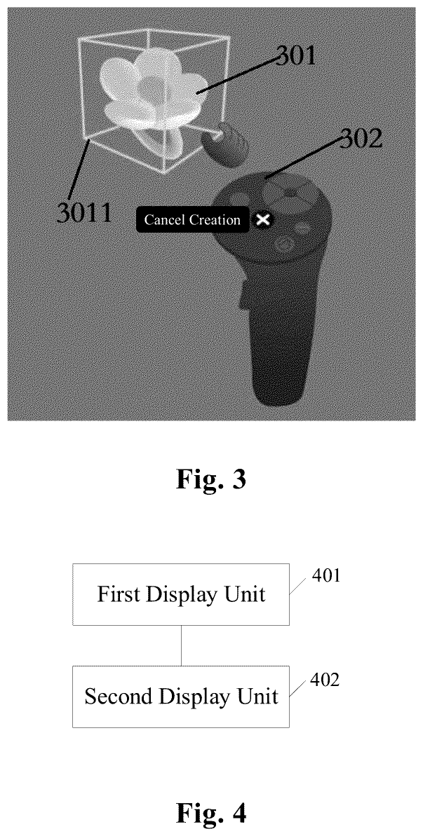

In order to facilitate a better understanding, the description may be made in conjunction with FIG. 3. FIG. 3 may be understood as a schematic diagram of displaying a selected three-dimensional model at a first end of the movable predefined three-dimensional object after performing a select instruction on a certain two-dimensional thumbnail. As can be seen from FIG. 3, a schematic diagram of a selected three-dimensional model 302 may be displayed at a first end 3011 of a movable predefined three-dimensional object 301, and a model bounding box may be displayed around the periphery of the three-dimensional model. The shape of the model bounding box may be the same as the shape of the solid frame. Of course, in specific embodiments, the specific shape of the bounding box may be set according to the actual situation. For example, it may also be a sphere, a cone, or other solid shapes.

With further reference to FIG. 4, as an implementation of the methods shown in the above figures, the present disclosure provides one or more embodiments of a display apparatus. The apparatus embodiment corresponds to the display method embodiment shown in FIG. 1, and the apparatus may be applied to various electronic devices.

As shown in FIG. 4, the display apparatus of the present embodiment includes: a first display unit 401, configured to display a two-dimensional thumbnail corresponding to a three-dimensional model on a human-computer interaction interface; and a second display unit 402, configured to, in response to detecting a select operation on a displayed two-dimensional thumbnail, display a solid frame at a display position of a selected two-dimensional thumbnail, and display a display object corresponding to the selected two-dimensional thumbnail within the solid frame.

In some embodiments, the above-mentioned display object includes the selected two-dimensional thumbnail and/or a sub three-dimensional model, wherein the sub three-dimensional model indicates the selected three-dimensional model, and the selected three-dimensional model corresponds to the selected two-dimensional thumbnail.

In some embodiments, the above-mentioned second display unit 402 is further specifically configured to: move the selected two-dimensional thumbnail from an original position into the solid frame in a predefined manner.

In some embodiments, the above-mentioned second display unit 402 is further specifically configured to: move the selected two-dimensional thumbnail from the original position into the solid frame along a direction indicated by a first normal vector, wherein the first normal vector is a normal vector of the human-computer interaction interface.

In some embodiments, when the selected two-dimensional thumbnail is displayed in the solid frame, the selected two-dimensional thumbnail is parallel to the human-computer interaction interface.

In some embodiments, the selected two-dimensional thumbnail is coplanar with the center of the solid frame.

In some embodiments, the three-dimensional model corresponds to a bounding box, and the bounding box is configured to surround three-dimensional models. The display apparatus is further specifically configured to: based on a first shape information of the bounding box corresponding to the selected three-dimensional model, determine a second shape information of the solid frame, wherein the selected two-dimensional thumbnail corresponds to the selected three-dimensional model.

In some embodiments, the above-mentioned human-computer interaction interface is displayed in a target virtual space; and the target virtual space further displays a movable predefined three-dimensional object, wherein the movable predefined three-dimensional object is configured to move the selected three-dimensional model according to a move operation by a user. The display apparatus is further specifically configured to: in response to detecting a select instruction for the selected two-dimensional thumbnail, display the selected three-dimensional model at a first end of the movable predefined three-dimensional object.

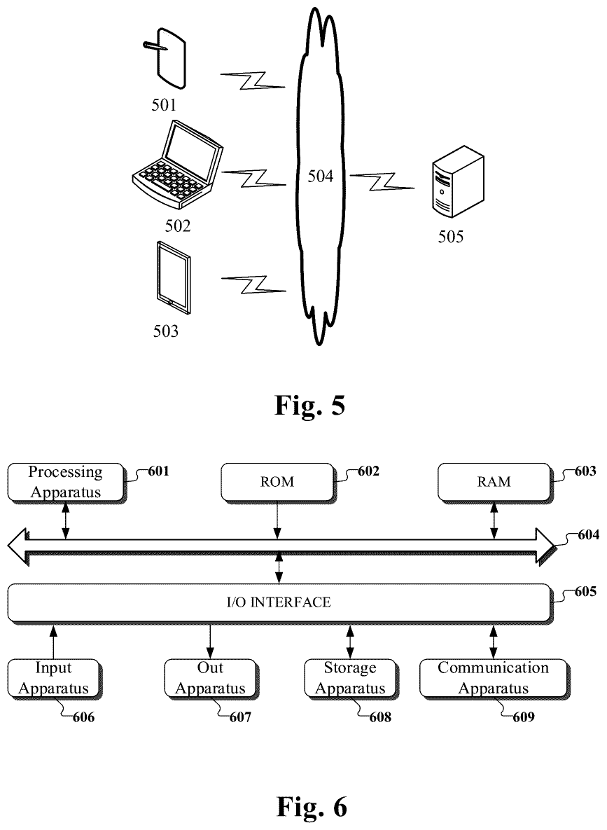

Refer to FIG. 5. FIG. 5 illustrates an exemplary system architecture in which a display method according to one or more embodiments of the present disclosure may be applied.

As shown in FIG. 5, the system architecture may include terminal devices 501, 502, and 503, a network 504, and a server 505. The network 504 may be a medium used to provide communication links between the terminal devices 501, 502, and 503 and the server 505. The network 504 may include various connection types, such as wired communication link, wireless communication link, or fiber optic cables.

The terminal devices 501, 502, and 503 may interact with the server 505 through the network 504 to receive or send messages. Various client applications may be installed on the terminal devices 501, 502, and 503, such as web browser applications, search applications, and news and information applications. The client applications in the terminal devices 501, 502, and 503 may receive the user's instructions and complete corresponding functions according to the user's instructions, such as adding corresponding information to the information according to the user's instructions.

The terminal devices 501, 502, and 503 may be hardware or software. When the terminal devices 501, 502, and 503 are hardware, they may be various electronic devices with display screens and supporting web browsing, including but not limited to smartphones, tablets, e-book readers, MP3 (Moving Picture Experts Group Audio Layer III) players, MP4 (Moving Picture Experts Group Audio Layer IV) players, laptops and desktop computers, etc. When the terminal devices 501, 502, and 503 are software, they may be installed in the electronic devices listed above. They may be implemented as multiple software or software modules (such as software or software modules used to provide distributed services), or as a single software or software module. There are no specific limitations here.

The server 505 may be a server that provides various services, such as receiving information acquisition requests sent by the terminal devices 501, 502, and 503, and acquiring display information corresponding to the information acquisition requests in various ways according to the information acquisition requests. And the relevant data of the display information is sent to the terminal devices 501, 502, and 503.

It should be noted that the information processing method provided by the embodiments of the present disclosure may be executed by a terminal device, and accordingly, the display apparatus may be provided in the terminal devices 501, 502, and 503. In addition, the information processing method provided by the embodiments of the present disclosure may also be executed by the server 505, and accordingly, the information processing apparatus may be provided in the server 505.

It should be understood that the number of the terminal devices, networks and servers in FIG. 5 is only illustrative. Depending on implementation needs, there can be any number of terminal devices, networks, and servers.

Now refer to FIG. 6, which illustrates a structural schematic diagram of an electronic device (such as the terminal device or server in FIG. 5) suitable for implementing the embodiment of the present disclosure. The terminal devices in the embodiments of the present disclosure may include, but are not limited to, mobile terminals such as mobile phones, laptops, digital broadcast receivers, PDAs (Personal Digital Assistants), PADs (Tablets), PMPs (Portable Multimedia Players), and vehicle-mounted terminals (e.g., vehicle-mounted navigation terminals), and fixed terminals such as digital TVs, desktop computers, and the like. The electronic devices shown in FIG. 6 is only an example, and should not impose any limitations on the functions and scope of use of the embodiments of the present disclosure.

As shown in FIG. 6, the electronic device may include a processing apparatus (e.g., a central processing unit, a graphics processing unit, etc.) 601, which may perform various appropriate actions and processes according to the program stored in a read-only memory (ROM) 602 or loaded from a storage apparatus 608 into a random access memory (RAM) 603. In the RAM 603, various programs and data required for the operation of the electronic device 600 are also stored. The processing apparatus 601, the ROM 602 and the RAM 603 are connected to each other via a bus 604. An input/output (I/O) interface 605 is also connected to the bus 604.

Typically, the following apparatuses may be connected to the I/O interface 605: an input apparatus 606 including, for example, a touch screen, a touch pad, a keyboard, a mouse, a camera, a microphone, an accelerometer, a gyroscope; an output apparatus 607 including, for example, a liquid crystal display (LCD), a speaker, a vibrator; a storage apparatus 608 including, for example, a magnetic tape, a hard disk; and a communication apparatus 609. The communication apparatus 609 may allow the electronic device to communicate wirelessly or wiredly with other devices to exchange data. Although FIG. 6 illustrates an electronic device having various apparatuses, it should be understood that implementation or availability of all illustrated apparatuses is not required. More or fewer apparatuses may alternatively be implemented or provided.

In particular, according to the embodiment of the present disclosure, the processes described above with reference to the flowchart may be implemented as a computer software program. For example, the embodiments of the present disclosure comprise a computer program product including a computer program carried on a non-transitory computer-readable medium, and the computer program includes program code for performing the method illustrated in the flowchart. In such embodiment, the computer program may be downloaded and installed from the network via communication apparatus 609, or installed from storage apparatus 608, or installed from the ROM 602. When the computer program is executed by the processing apparatus 601, the above functions defined in the method of the embodiment of the present disclosure are performed.

It should be noted that the above-mentioned non-transitory computer-readable medium in the present disclosure may be a computer-readable signal medium or a computer-readable storage medium, or any combination of the above two. The computer-readable storage medium may be, for example, but is not limited to, an electrical, magnetic, optical, electromagnetic, infrared, or semiconductor system, apparatus or device, or any combination thereof. More specific examples of the computer-readable storage media may include, but are not limited to, electrical connections having one or more wires, portable computer disks, hard disks, Random Access Memory (RAM), Read-Only Memory (ROM), Erasable Programmable Read-Only Memory (EPROMM or flash memory), optical fibers, portable Compact Disc Read-Only Memory (CD-ROM), optical storage devices, magnetic storage devices, or any suitable combination of the above. In the present disclosure, a computer-readable storage medium may be any tangible medium that contains or stores a program for use by or in connection with an instruction execution system, apparatus, or device. In the present disclosure, a computer-readable signal medium may include a data signal propagated in baseband or as part of a carrier wave, carrying computer-readable program code therein. Such propagated data signals may take a variety of forms, including but not limited to electromagnetic signals, optical signals, or any suitable combination of the above. A computer-readable signal medium may further be any computer-readable medium other than a computer-readable storage medium that can send, propagate, or transmit a program for use by or in connection with an instruction execution system, apparatus, or device. Program code contained on a computer-readable medium may be transmitted using any appropriate medium, including but not limited to: wires, optical cables, Radio Frequency (RF), or any suitable combination of the above.

In some embodiments, the client/server may communicate utilizing any currently known or future developed network protocol, such as HyperText Transfer Protocol (HTTP), and may be interconnected with any form or medium of digital data communications (e.g., communication network). Examples of communication networks include Local Area Networks (LANs), Wide Area Networks (WANs), International Networks (e.g., the Internet), and end-to-end networks (e.g., ad hoc end-to-end network), and any current network for knowledge or future research and development.

The above computer-readable medium may be included in the above-mentioned electronic device; it may also exist independently without being assembled into the electronic device.

The above computer-readable medium carries one or more programs. When the above one or more programs are executed by the electronic device, cause the electronic device to: display a two-dimensional thumbnail corresponding to a three-dimensional model on a human-computer interaction interface; and in response to detecting a select operation on the displayed two-dimensional thumbnail, display a solid frame at a display position of a selected two-dimensional thumbnail, and display a display object corresponding to the selected two-dimensional thumbnail within the solid frame.

Computer program code for performing the operations of the present disclosure may be written in one or more programming languages, or a combination thereof. The above programming languages include, but are not limited to, object-oriented programming languages such as Java, Smalltalk, and C++, and also include conventional procedural programming languages such as “C” language or similar programming languages. The program code may execute entirely on the user's computer, partly on the user's computer, as a stand-alone software package, partly on the user's computer and partly on a remote computer, or entirely on the remote computer or server. In situations involving remote computers, the remote computer may be connected to the user's computer through any kind of network, including LAN or WAN, or may be connected to an external computer (such as through the Internet using an Internet service provider).

The flowcharts and block diagrams in the drawings illustrate the architecture, functionality, and operations of possible implementations of systems, methods, and computer program products according to various embodiments of the present disclosure. In this regard, each block in the flowchart or block diagram may represent a module, segment, or portion of code, which contains one or more executable instructions for implementing the specified logical function. It should also be noted that, in some alternative implementations, the functions noted in the block may occur in a different order than that noted in the drawings. For example, two blocks shown one after another may actually execute substantially in parallel, or they may sometimes execute in the reverse order, depending on the functionality involved. It should be noted that each block of the block diagram and/or flowchart illustration, and combinations of blocks in the block diagram and/or flowchart illustration, may be implemented by special purpose hardware-based systems that perform the specified functions or operations, or may be implemented using a combination of specialized hardware and computer instructions.

The units involved in the embodiments of the present disclosure may be implemented in software or hardware. Wherein, the name of a module in a case does not constitute a limitation of the unit itself. For example, the first display unit 401 may also be described as “the unit acquiring the first information cluster”.

The functions described above herein may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSP), System on Chips (SOCs), and Complex Programmable Logic Devices (CPLDs), etc.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may include, but are not limited to, electronic, magnetic, optical, electromagnetic, infrared, or semiconductor systems, apparatuses or devices, or any suitable combination of the above. More specific examples of the machine-readable storage medium may include electrical connections having one or more wires, portable computer disks, hard disks, Random Access Memory (RAM), Read-Only Memory (ROM), Erasable Programmable Read-Only Memory (EPROMM or flash memory), optical fibers, portable Compact Disc Read-Only Memory (CD-ROM), optical storage devices, magnetic storage devices, or any suitable combination of the above.

Additionally, in related technologies, in VR, AR and MR scenes, when dyeing objects in a display screen, a user needs to open a color palette, select a required target color from the color palette, change the brush color in the display screen to the target color, and then use the brush to dye the objects in the display screen. Such dyeing method is relatively single and less flexible.

Embodiments of the present disclosure provide a data processing method, apparatus, electronic device, and storage medium for an implementation that is different from conventional technologies that: when dyeing objects in a display screen, a user needs to open a color palette, select a required target color from the color palette, change the brush color in the display screen to the target color, and then use the brush to dye the objects in the display screen, resulting in the dyeing method relatively single and less flexible.

The technical solution of the present disclosure will be described in detail below with the embodiments. The following embodiments may be combined with each other, and the same or similar concepts or processes may not be described again in some embodiments. The embodiments of the present disclosure will be described below with reference to the drawings.

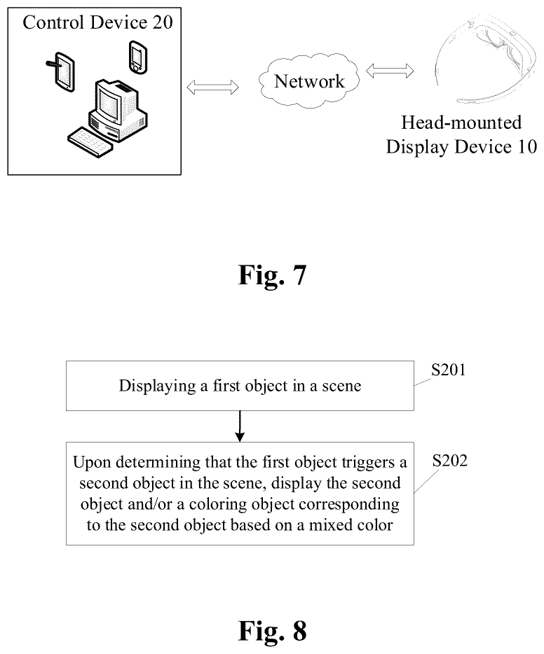

FIG. 7 is a structural schematic diagram of a system provided by an exemplary embodiment of the present disclosure. The system comprises: a head-mounted display device 10 and a control device 20. The head-mounted display device 10 and the control device 20 are connected through a network, such as a wired or wireless network connection.

In one or more embodiments, the head-mounted display device 10 is used for the user to wear and interact with the user. Specifically, the user may interact with the head-mounted display device or the display content in the head-mounted display device through any one or more of various methods such as handles, gestures, motion capture gloves, voice, and eyeballs. Wherein, the display content in the head-mounted display device may be the content of the virtual reality screen, the content of the mixed reality screen, or the content of the augmented reality screen, or may be other types of content.

The afore-mentioned control device 20 may be a device such as a terminal or a server. The terminal may be a device such as a smartphone, a tablet, a laptop, an intelligent voice interaction device, a smart home appliance. The terminal may also include a client, which may be a video client, a browser client, or an instant messaging client. The server may be an independent physical server, or a server cluster or distributed system composed of a plurality of physical servers, or a cloud server that provides basic cloud computing service, such as cloud service, cloud database, cloud computing, cloud function, cloud storage, network service, cloud communication, middleware service, domain name service, security service, Content Delivery Network (CDN), and big data and artificial intelligence platform.

In some embodiments, the afore-mentioned control device 20 may be configured to provide the afore-mentioned display content for the head-mounted display device 10. When the head-mounted display device 10 displays screen content received from the control device 20, the control device 20 may be configured to perform the following data processing method: displaying a first object in a scene; and upon determining that the first object triggers a second object in the scene, displaying the second object and/or a coloring object corresponding to the second object based on a mixed color, wherein the mixed color is determined based on a color corresponding to the first object and a color corresponding to the second object.

Optionally, the scene may be any of the following scenes: a virtual reality scene, a mixed reality scene, or an augmented reality scene. The scene may specifically be a three-dimensional game scene, a three-dimensional design scene, etc.

Optionally, the first object and the second object are virtual objects in a display screen of the current scene, and the display screen is displayed on a display in the head-mounted display device. The display screen may be a three-dimensional screen.

Optionally, the first object and the second object may each correspond to a color.

Optionally, the first object and the second object may be color palettes.

Optionally, the first object and the second object may further be buttons, or may be other objects, such as luminous columns.

Optionally, the color corresponding to the first object is the color of the first object.

Optionally, the color corresponding to the second object is the color of the second object.

Optionally, the coloring object corresponding to the second object may be a virtual object in the display screen of the current scene. The coloring object is in a shape of a beam, and the coloring object has a starting end and a beam direction, that is, an illumination direction.

Optionally, the starting end of the coloring object corresponding to the second object is in contact with the second object.

In another embodiment, the afore-mentioned data processing method may also be executed by the head-mounted display device 10 itself. The system may also only include the head-mounted display device 10, that is, the head-mounted display device is an all-in-one machine. In this case, the head-mounted display device 10 is configured to: display a first object in a scene; and upon determining that the first object triggers a second object in the scene, display the second object and/or a coloring object corresponding to the second object based on a mixed color, wherein the mixed color is determined based on a color corresponding to the first object and a color corresponding to the second object. Wherein, the head-mounted display device 10 is provided with a display for displaying the display screen corresponding to the afore-mentioned scene.

The detailed embodiments of the afore-mentioned data processing method and the specific functions of the afore-mentioned head-mounted display device 10 or the control device 20 will be described in detail below, respectively. It should be noted that the description order of the following embodiments is not used to limit the priority order of the embodiments.

FIG. 8 is a schematic flowchart of a data processing method provided by an exemplary embodiment of the present disclosure. The execution subject of the method may be the afore-mentioned head-mounted display device 10, or may also be the afore-mentioned control device 20. The method includes at least the following S201-S202:

S201: Displaying a first object in a scene.

In some embodiments, the scene is any of the following scenes: a virtual reality scene, a mixed reality scene, or an augmented reality scene. The scene may specifically be a three-dimensional game scene, a three-dimensional design scene, etc.

Optionally, the first object is a virtual object in the display screen of the current scene, and the display screen is displayed on a display in the head-mounted display device. The display screen may be a three-dimensional screen.

S202: Upon determining that the first object triggers a second object in the scene, display the second object and/or a coloring object corresponding to the second object based on a mixed color, wherein the mixed color is determined based on a color corresponding to the first object and a color corresponding to the second object.

Optionally, the second object is a virtual object in the display screen of the current scene.

In some embodiments provided by the present disclosure, regarding how to determine that the first object triggers the second object in the scene, the method further comprises: upon detecting that a first user selects the first object and selects the second object within a preset duration after selecting the first object, determining that the first object triggers the second object in the scene.

Optionally, upon determining that the first object or the coloring object corresponding to the first object is in contact with the second object in the scene, it is determined that the first object triggers the second object in the scene.

Correspondingly, the afore-mentioned method further comprises: displaying a coloring object corresponding to the first object; upon determining that the coloring object corresponding to the first object is in contact with the second object, determining that the first object triggers the second object in the scene.

Wherein, the coloring object described in the present disclosure is a virtual object in the display screen of the current scene. The coloring object may be in a shape of a beam, and the coloring object has a starting end and a beam direction, that is, an illumination direction. Optionally, the starting end of the coloring object is in contact with its corresponding object. For example, the starting end of the coloring object corresponding to the first object is in contact with the first object.

In some embodiments provided by the present disclosure, regarding how to determine that the first object triggers the second object in the scene, the method further comprises S3001-S3002:

S3001: Acquiring a first control parameter for a first user to control the first object.

Optionally, the first user may control the movement of the first object by operating a handheld apparatus. The afore-mentioned first control parameter may be a control parameter of the handheld apparatus by the first user.

S3002: Determining, based on the first control parameter, that the first object triggers the second object in the scene.

Optionally, in the afore-mentioned S3002, determining, based on the first control parameter, that the first object triggers the second object in the scene, may comprise: determining the position of the first object based on the first control parameter; and upon determining that the distance between the position of the first object and the position of the second object is less than a preset distance, determining that the first object triggers the second object in the scene.

Optionally, displaying the second object based on the mixed color, comprises: adjusting the color of the second object to the mixed color.

Optionally, displaying the coloring object corresponding to the second object based on the mixed color, comprises: adjusting the color of the second object to the mixed color; and adjusting the color of the coloring object corresponding to the second object to the mixed color.

Optionally, displaying the coloring object corresponding to the second object based on the mixed color, comprises: adjusting the color of the second object to the mixed color; displaying the coloring object corresponding to the second object, wherein the color of the coloring object corresponding to the second object is the mixed color.

In some embodiments provided by the present disclosure, regarding determining the mixed color, the method further comprises S41-S42:

S41: Acquiring the color corresponding to the first object and the color corresponding to the second object.

S42: Determining the mixed color based on the color corresponding to the first object and the color corresponding to the second object.

Optionally, the color corresponding to the first object and the color corresponding to the second object may be determined according to a first preset correspondence relationship, wherein the first preset correspondence relationship includes a plurality of objects and the colors corresponding to each object.

Optionally, the color corresponding to the first object may be the color of the first object, or the color of the coloring object corresponding to the first object. Optionally, the color of the first object is the same as the color of the coloring object corresponding to the first object.

Optionally, the color corresponding to the second object may be the color of the second object, or the color of the coloring object corresponding to the second object. Optionally, the color of the second object is the same as the color of the coloring object corresponding to the second object.

Optionally, in S42, determining the mixed color based on the color corresponding to the first object and the color corresponding to the second object, comprises S421-S422:

S421: Acquiring a second preset correspondence relationship. The second preset corresponding relationship includes a plurality of color combinations and a target color corresponding to each of the plurality of color combinations. The target color is a mixed color of a plurality of sub-colors included in the corresponding color combination.

S422: Determining the mixed color corresponding to the color combination of a plurality of sub-colors included in the second preset correspondence relationship including the color corresponding to the first object and the color corresponding to the second object as the mixed color.

Optionally, the target color corresponding to each color combination may be determined based on the three primary color rules of light.

Optionally, the target color corresponding to each color combination may be determined based on the three primary color rules of pigments.

Optionally, the target color corresponding to each color combination may also be set by relevant personnel.

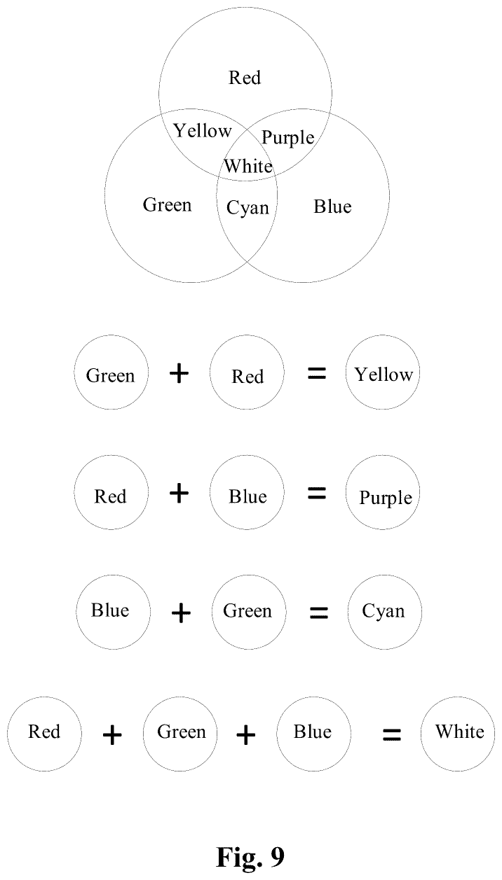

Specifically, as shown in FIG. 9, FIG. 9 is a schematic diagram of a color combination and its corresponding mixed first color provided by an exemplary embodiment of the present disclosure. The three primary colors of light are red, green, and blue (RGB). The combination of these three colors, RGB, may form almost all colors. The light will become brighter by adding, and mixing any two of the colors may get a brighter intermediate color. For example: green+red=yellow; red+blue=purple; blue+green=cyan. Combining three colors in equal amounts may get white, that is, red+green+blue=white. In addition, the second preset correspondence relationship also includes other color combinations and their corresponding target colors.

For example, in the second preset correspondence relationship, the target color corresponding to a color combination including sub-colors red and blue is purple.

Optionally, before determining that the first object triggers the second object in the scene, the method further comprises: upon determining that a third object triggers the second object, determining the color corresponding to the second object based on the color corresponding to the third object, wherein the third object is a virtual object in the scene.

Optionally, the third object may be a color palette.

Optionally, the third object may be a button, or may further be other objects, such as luminous columns.

In some embodiments provided by the present disclosure, regarding how to determine that the third object triggers the second object, the method further comprises: upon detecting that a second user selects the third object and selects the second object within a preset duration after selecting the third object, determining that the third object triggers the second object in the scene.

Optionally, upon determining that the third object or the coloring object corresponding to the third object is in contact with the second object in the scene, it is determined that the third object triggers the second object in the scene.

Wherein, the coloring object described in the present disclosure is a virtual object in the display screen of the current scene. The coloring object is in a shape of a beam, and the coloring object has a starting end and a beam direction, that is, an illumination direction. Optionally, the starting end of the coloring object is in contact with its corresponding object. For example, the starting end of the coloring object corresponding to the third object is in contact with the third object.

In some embodiments provided by the present disclosure, regarding how to determine that the third object triggers the second object in the scene, the method further comprises S031-S032:

S031: Acquiring a second control parameter for a second user to control the third object.

Optionally, the second user may control the movement of the third object by operating a handheld apparatus. The afore-mentioned second control parameter may be a control parameter of the handheld apparatus by the second user.

S032: Determining, based on the second control parameter, that the third object triggers the second object in the scene.

Optionally, in the afore-mentioned S032, determining, based on the second control parameter. that the third object triggers the second object in the scene, may comprise: determining the position of the third object based on the second control parameter; and upon determining that the distance between the position of the third object and the position of the second object is less than a preset distance, determining that the third object triggers the second object in the scene.

Optionally, determining the color corresponding to the second object based on the color corresponding to the third object, comprises: using the color corresponding to the third object as the color corresponding to the second object.

Wherein, the color corresponding to the third object is the color of the third object.

Optionally, the color corresponding to the third object is the same as the color of the coloring object corresponding to the third object.

In some embodiments provided by the present disclosure, before determining that the first object triggers the second object in the scene, the method further comprises:

Upon determining that the third object triggers the second object, displaying the second object and/or the coloring object corresponding to the second object based on the color corresponding to the third object.

Optionally, displaying the second object based on the color corresponding to the third object, comprises: adjusting the color of the second object to the color corresponding to the third object; and adjusting the color of the coloring object corresponding to the second object to the color corresponding to the third object.

Optionally, displaying the coloring object corresponding to the second object based on the color corresponding to the third object, comprises: adjusting the color of the second object to the color corresponding to the third object; and displaying the coloring object corresponding to the second object, wherein the color of the coloring object corresponding to the second object is the color corresponding to the third object.

Optionally, the afore-mentioned first user and the second user may or may not be the same user.

The solution of the present disclosure is suitable for multi-user scenes. A plurality of users may be in the scene at the same time and jointly realize the dyeing of the objects to be dyed. This is more interesting and the dyeing method is more flexible.

Optionally, the method further comprises: determining whether the first user selects the first object; and if so, performing acquiring the first control parameter for the first user to control the first object.

Specifically, upon determining that the corresponding target virtual object of the first user in the scene holds the first object, it may be determined that whether the first user selects the first object. Optionally, the target virtual object is a virtual cartoon object of the control object in the camera coordinate system (the above scene).

Optionally, the method further comprises the following S31-S34:

S31: Acquiring a first position information of a control object (such as a handheld apparatus) configured for the first user to select or move the first object, wherein the first position information is a coordinate information in a world coordinate system. Specifically, the determination of coordinate information may refer to related technologies, such as GPS technology, which will not be described again here.

S32: Determining a second position information of a target virtual object corresponding to the control object in the scene based on the first position information and a preset coordinate conversion relationship.

S33: Acquiring a third position information provided at a selected object of the first object.

Wherein, the selected object of the first object may be the first object itself.

Optionally, the selected object of the first object may be a held object connected to the first object, wherein after the first object holds the held object, the first object may be moved or rotated through the handheld apparatus.

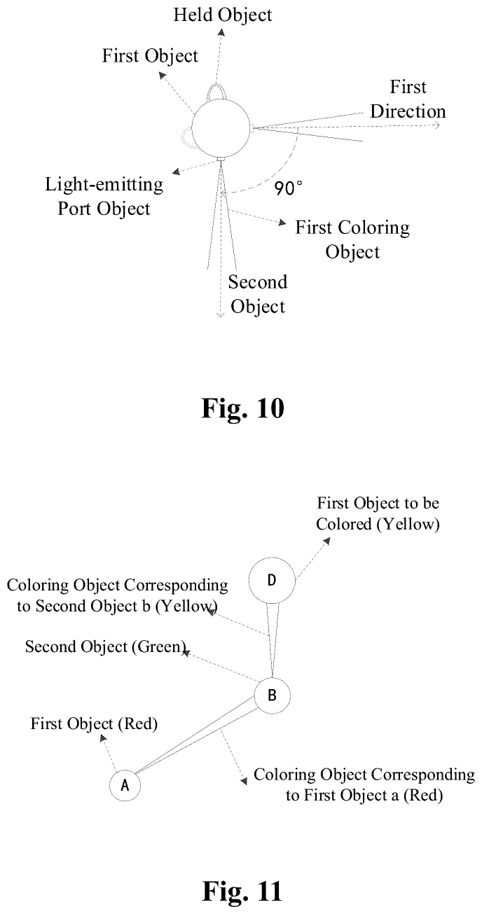

Optionally, a light-emitting port object is also provided on the first object. Further, as shown in FIG. 10, the first object is connected to the coloring object corresponding to the first object through the light-emitting port object.

When the first user rotates the first object, the coloring object corresponding to the first object rotates accordingly.

FIG. 10 is a schematic diagram of controlling and changing a beam direction of the coloring object corresponding to a first object, when the coloring object is in the shape of a beam, provided by an exemplary embodiment of the present disclosure. The direction of the beam before the coloring object corresponding to the first object is changed is a first direction. When a first user controls to rotate the first object by 90°, the coloring direction of the first object is also rotated by 90°, and the beam direction of the coloring object corresponding to the first object changes from the first direction to a second direction.

It should be noted that, the coloring objects in the present disclosure and their corresponding objects are connected through corresponding light-emitting port objects, and the coloring objects move or rotate with their corresponding objects.

S34: Upon detecting that a distance between the second location information and the third location information is less than a preset distance, determining that the first user selects the first object; otherwise, determining that the first user does not select the first object.

In some other embodiments, upon detecting that a distance between the second location information and the third location information is less than a preset distance, and upon determining that a gesture information of a target virtual object corresponding to the first user in the scene matches the preset gesture information, it is determined that the first user selects the first object.

Optionally, the method further comprises: upon determining that the first user selects the first object, displaying a preset gesture corresponding to the target virtual object.

Specifically, the preset gesture corresponding to the target virtual object may be a gesture of a left hand model, or may be a gesture of a right hand model. Specifically, it may be determined based on the actual operation of the user.

In some embodiments provided by the present disclosure, the method further comprises S311-S312:

S311: Displaying a first object to be colored.

In some embodiments, the first object to be colored is a virtual object in the afore-mentioned scene, that is, in the camera coordinate system. For example, the first object to be colored may be one or more of doors, pillars, walls, etc. in the current scene.

In some other embodiments, the first object to be colored may also be pre-selected.

S312: Upon determining that the second object triggers the first object to be colored, displaying the first object to be colored based on the mixed color.

In some embodiments provided by the present disclosure, regarding how to determine that the second object triggers the first object to be colored in the scene, the method further comprises: upon detecting that the third user selects the second object, and selects the first object to be colored within a preset duration after selecting the second object, determining that the second object triggers the first object to be colored in the scene.

Optionally, the third user may be a user other than the first user and the second user, or may be the first user or the second user. The solution of the present disclosure may be applied to multi-user scenes, making the dyeing process more interesting.

Optionally, upon determining that the second object or the coloring object corresponding to the second object is in contact with the first object to be colored in the scene, it is determined that the second object triggers the first object to be colored in the scene.

In some embodiments provided by the present disclosure, regarding how to determine that the second object triggers the first object to be colored in the scene, the method further comprises: acquiring a third control parameter for the third user to control the second object; and determining, based on the third control parameter, that the second object triggers the first object to be colored in the scene.

Optionally, the third user may control the movement of the second object by operating the handheld apparatus. The afore-mentioned third control parameter may be a control parameter of the handheld apparatus by the third user.

Optionally, determining, based on the third control parameter, that the second object triggers the first object to be colored in the scene, may comprise: determining the position of the second object based on the third control parameter; and upon determining that the distance between the position of the second object and the position of the first object to be colored is less than a preset distance, determining that the second object triggers the first object to be colored in the scene.

Wherein the third user may control the second object to move or rotate by controlling the handheld apparatus.

Optionally, the handheld apparatus described in the present disclosure may be a handle, a motion capture glove, etc.

Optionally, in S312, displaying the first object to be colored based on the mixed color, comprises: adjusting the color of the first object to be colored to the mixed color.

Further, as shown in FIG. 11, FIG. 11 is a schematic diagram of a scene provided by an exemplary embodiment of the present disclosure. The display screen in the current scene includes a first object (A), a second object (B), a coloring object (a) corresponding to the first object, a coloring object (b) corresponding to the second object, and a first object to be colored (D). Wherein, the color corresponding to (A) is red, and (A) is connected to a starting end of a beam of the corresponding (a). The color of (a) is the color corresponding to (A), that is, the color of (a) is red. The color corresponding to B is green. Upon detecting that (a) is in contact with B displayed in the scene, the color red of (a) and the color green corresponding to (B) are acquired. Based on the color red of (a) and the color green corresponding to (B), the color yellow after mixing red and green is determined. Taking the mixed color yellow as the color of (B), as well as the color of (b), and (b) is displayed.

Optionally, in the present disclosure, when determining whether two target objects are in contact, collision detection may also be used. Specifically: performing collision detection on the first target object and the second target object to acquire a collision detection result; when the collision detection result indicates that the first target object collides with the second target object, determining that the first target object is in contact with the second target object; when the collision detection result indicates that the first target object and the second target object do not collide, determining that the first target object is not in contact with the second target object.

Optionally, the first target object may be the first object, the coloring object corresponding to the first object, the second object, the coloring object corresponding to the second object, the third object, and the coloring object corresponding to the third object.

Optionally, the second target object may be the first object, the coloring object corresponding to the first object, the second object, the coloring object corresponding to the second object, the third object, and the coloring object corresponding to the third object.

Wherein, the first target object and the second target object are not the same object, and they are not the same coloring object.

Optionally, a reflecting object may also be displayed in the current scene. The method further comprises:

Upon detecting that the first target object is in contact with the reflecting object, displaying a first reflective object. The first reflecting object is a virtual object in the camera coordinate system. The first reflecting object is in a shape of a beam, and a starting end of the first reflecting object is connected to the reflecting object. The color of the first reflecting object is the color of the first target object.

Wherein, the reflecting object is a plane object. The coloring direction of the first reflecting coloring object is determined based on the reflection principle and based on the coloring direction of the first target object and the normal direction of the reflecting object.

In some embodiments, after displaying the first object to be colored based on the mixed color, the method further comprises: when the mixed color meets a preset requirement, performing a preset instruction.

Optionally, when the mixed color is a preset color, the mixed color may be regarded as meeting the preset requirements.

Optionally, the preset color corresponds to the first object to be colored, and the preset colors corresponding to different first objects to be colored may be different.

Optionally, the preset instruction includes: an instruction for controlling the start of the next task, such as an instruction for starting the next level of a game, etc.

In some other embodiments, the preset instruction includes: an instruction for controlling the display of a preset prompt information, wherein the preset prompt information is used to prompt that dyeing is completed. The preset prompt information may include text information and/or audio information.

The solution of the present disclosure may trigger the associated preset instructions based on whether the mixed color meets the preset requirements as a trigger condition, and the method of triggering the instruction is more flexible. In a case that one user controls the completion of color mixing multiple times, or that a plurality of users control the completion of color mixing separately, triggering the instruction based on whether the mixed color meets the preset requirements may result in a stronger sense of interaction.

Optionally, displaying the first object to be colored based on the mixed color comprises: adjusting the color of the first object to be colored to the mixed color.

Further, as shown in FIG. 11, when (b) is in contact with (D), it is deemed that (B) triggers (D). In this case, the color of (D) is adjusted to yellow.

Optionally, different first objects to be colored may correspond to different tasks, and their corresponding preset colors may also be different.

Optionally, the method further comprises: displaying a plurality of second objects to be colored, and the first object to be colored is one of the plurality of second objects to be colored.

In some embodiments provided by the present disclosure, the method further comprises: based on the preset color corresponding to the first object to be colored, displaying the preset color text information corresponding to the preset color on the first object to be colored to prompt the user for the trigger color of the task corresponding to the first object to be colored. For example, the preset color text information may be text information with the word “yellow”.

In some other embodiments provided by the present disclosure, the method further comprises: coloring the first object to be colored based on the preset color corresponding to the first object to be colored, to prompt the user with the trigger color of the task corresponding to the first object to be colored.

Optionally, the beam direction of the coloring object in the embodiment of the present disclosure may be a horizontal direction.

Optionally, the user may set relevant parameters of the coloring object, such as setting a length parameter, to determine the length of the coloring object.

The solution provided by the present disclosure that displaying a first object in a scene; and upon determining that the first object triggers a second object in the scene, displaying the second object and/or a coloring object corresponding to the second object based on a mixed color, wherein the mixed color is determined based on a color corresponding to the first object and a color corresponding to the second object, may flexibly select an object corresponding to a color, determine different mixed colors, thereby effectively improving the flexibility of the dyeing method for objects in the display screen.

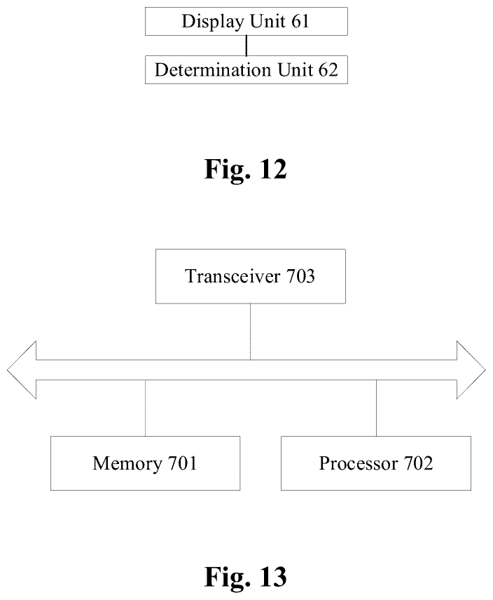

FIG. 12 is structural schematic diagram of a data processing apparatus provided by an exemplary embodiment of the present disclosure, wherein the apparatus comprises:

A display unit 61, configured to display a first object in a scene.

A determination unit 62, configured to determine that the first object triggers a second object.

Wherein, the display unit 61 is further configured to upon the determination unit 62 determining that the first object triggers the second object in the scene, display the second object and/or a coloring object corresponding to the second object based on a mixed color, wherein the mixed color is determined based on a color corresponding to the first object and a color corresponding to the second object.

Optionally, the apparatus is further configured to: display the first object to be colored; and upon determining that the second object triggers the first object to be colored, display the first object to be colored based on the mixed color.

Optionally, the apparatus is further configured to: acquire a first control parameter for a first user to control the first object; and determine, based on the first control parameter, that the first object triggers the second object in the scene.

Optionally, before determining that the first object triggers the second object in the scene, the apparatus is further configured to: upon determining that a third object triggers the second object, determine the color corresponding to the second object based on the color corresponding to the third object, wherein the third object is a virtual object in the scene.

Optionally, the apparatus is further configured to: acquire a second control parameter for a second user to control the third object; and determine, based on the second control parameter, that the third object triggers the second object, wherein the second control parameter is a parameter for the second user to control the third object.

Optionally, the apparatus is further configured to: display a coloring object corresponding to the first object; upon determining that the coloring object corresponding to the first object is in contact with the second object, determine that the first object triggers the second object in the scene.

Optionally, the apparatus is further configured to: determine whether the first user selects the first object; and if so, perform acquiring the first control parameter for the first user to control the first object.

Optionally, the apparatus is further configured to: acquire a first position information of a control object configured for the first user to select or move the first object, wherein the first position information is a coordinate information in a world coordinate system; determine a second position information of a target virtual object corresponding to the control object in the scene based on the first position information and a preset coordinate conversion relationship; acquire a third position information provided at a selected object of the first object; upon detecting that a distance between the second location information and the third location information is less than a preset distance, determine that the first user selects the first object.

Optionally, the apparatus is further configured to: upon determining that a gesture information of a target virtual object corresponding to the first user in the scene matches the preset gesture information, determine that the first user selects the first object.

Optionally, the apparatus is further configured to: upon determining that the first user selects the first object, display a preset gesture corresponding to the target virtual object.

Optionally, the apparatus is further configured to: when the mixed color meets a preset requirement, perform a preset instruction.

It should be understood that, the apparatus embodiments and method embodiments may correspond to each other, and similar descriptions may refer to the method embodiments. To avoid repetition, they will not be repeated here. Specifically, the apparatus may execute the above method embodiments, and the foregoing and other operations and/or functions of each module in the apparatus are respectively for the corresponding processes in each method in the above method embodiments. For the sake of brevity, no further details will be given here.

The apparatus of the embodiment of the present disclosure is described above from the perspective of functional modules in conjunction with the drawings. It should be understood that the functional module may be implemented in the form of hardware, may also be implemented through instructions in the form of software, or may also be implemented through a combination of hardware and software modules. Specifically, each step of the method embodiment in the embodiments of the present disclosure may be completed by instructions in the form of software and/or integrated logic circuits of hardware in a processor. The steps of the methods disclosed in conjunction with the embodiments of the present disclosure may be directly implemented by a hardware decoding processor, or executed by a combination of hardware and software modules in a decoding processor. Optionally, the software module may be located in a mature storage medium in the field such as random access memory, flash memory, read-only memory, programmable read-only memory, electrically erasable programmable memory, register, etc. The storage medium is located in the memory, and the processor reads the information in the memory and completes the steps in the above method embodiment in combination with its hardware.

FIG. 13 is a structural schematic diagram of an electronic device provided by one or more embodiments of the present disclosure. The electronic device may comprise: a memory 701 and a processor 702. The memory 701 is configured to store computer programs and transmit the program code to the processor 702. In other words, the processor 702 may call and run the computer program from the memory 701, to implement the method in the embodiments of the present disclosure.

For example, the processor 702 may be configured to execute the above method embodiments according to instructions in the computer program.

In some embodiments of the present disclosure, the processor 702 may include but is not limited to: a general processor, a Digital Signal Processor (DSP), an Application Specific Integrated Circuit (ASIC), a Field Programmable Gate Array (FPGA), or other programmable logic devices, discrete gate or transistor logic devices, discrete hardware components, etc.

In some embodiments of the present disclosure, the memory 701 may include but is not limited to: a volatile memory and/or a non-volatile memory. Wherein, the nonvolatile memory may be a Read-Only Memory (ROM), a Programmable ROM (PROM), an Erasable PROM (EPROM), an electrically EPROM (EEPROM), or a flash memory. The volatile memory may be a Random Access Memory (RAM), which is used as an external cache. By an exemplary, not limited illustration, many forms of RAM are available, such as a Static RAM (SRAM), a Dynamic RAM (DRAM), a Synchronous DRAM (SDRAM), Double Data Rate SDRAM (DDRSDRAM), an Enhanced SDRAM (ESDRAM), a synch link DRAM (SLDRAM), and a Direct Rambus RAM (DR RAM).

In some embodiments of the present disclosure, the computer program may be divided into one or more modules, and the one or more modules are stored in the memory 701 and executed by the processor 702 to complete the method provided by the present disclosure. The one or more modules may be a series of computer program instruction segments capable of completing specific functions. The instruction segments are used to describe the execution process of the computer program in the electronic device.

As shown in FIG. 13, the electronic device may further comprise: a transceiver 703. The transceiver 703 is connected to the processor 702 or the memory 701.

Wherein, the processor 702 may control the transceiver 703 to communicate with other devices, specifically, may send information or data to or receive information or data from other devices. The transceiver 703 may include a transmitter and a receiver. The transceiver 703 may further include an antenna, and the number of antennas may be one or more.

It should be understood that various components in the electronic device are connected through a bus system, wherein in addition to the data bus, the bus system also includes a power bus, a control bus and a status signal bus.

The present disclosure further provides a non-transitory computer storage medium with a computer program stored thereon, wherein when the computer program is executed by a computer, cause the computer to perform the method of the above method embodiments. In other words, the embodiments of the present disclosure also provide a computer program product containing instructions. When the instructions are executed by a computer, cause the computer to perform the method of the above method embodiments.

When implemented using software, it may be implemented in whole or in part in the form of a computer program product. The computer program product includes one or more computer instructions. When the computer program instructions are loaded and executed on the computer, the processes or functions based on the embodiments of the present disclosure are generated in whole or in part. The computer may be a general purpose computer, a special purpose computer, a computer network, or other programmable apparatus. The computer instructions may be stored in or transmitted from one computer-readable storage medium to another computer-readable storage medium. For example, the computer instructions may be transmitted from one website, computer, server or data center to another website, computer, server or data center, through wired means (such as coaxial cable, optical fiber, digital subscriber line (DSL)) or wireless means (such as infrared, wireless microwave, etc.). The computer-readable storage medium may be any available medium that may be accessed by a computer or a data storage device such as a server or data center integrated with one or more available media. The available media may be magnetic media (e.g., floppy disk, hard disk, magnetic tape), optical media (e.g., digital video disc (DVD)), or semiconductor media (e.g., solid state disk (SSD)), etc.

According to one or more embodiments of the present disclosure, a data processing method is provided, comprising:
displaying a first object in a scene;
upon determining that the first object triggers a second object in the scene, displaying the second object and/or a coloring object corresponding to the second object based on a mixed color;
wherein the mixed color is determined based on a color corresponding to the first object and a color corresponding to the second object.

According to one or more embodiments of the present disclosure, the method further comprises:
displaying the first object to be colored;
upon determining that the second object triggers the first object to be colored, display the first object to be colored based on the mixed color.

According to one or more embodiments of the present disclosure, the method further comprises:
acquiring a first control parameter for a first user to control the first object;
determining, based on the first control parameter, that the first object triggers the second object in the scene.

According to one or more embodiments of the present disclosure, before determining that the first object triggers the second object in the scene, the method further comprises:
upon determining that a third object triggers the second object, determining the color corresponding to the second object based on the color corresponding to the third object, wherein the third object is a virtual object in the scene.

According to one or more embodiments of the present disclosure, the method further comprises:
acquiring a second control parameter for a second user to control the third object;
determining, based on the second control parameter, that the third object triggers the second object, wherein the second control parameter is a parameter for the second user to control the third object.

According to one or more embodiments of the present disclosure, the method further comprises:
displaying a coloring object corresponding to the first object;
upon determining that the coloring object corresponding to the first object is in contact with the second object, determine that the first object triggers the second object in the scene.

According to one or more embodiments of the present disclosure, the method further comprises:
determining whether the first user selects the first object; and if so, performing acquiring the first control parameter for the first user to control the first object.

According to one or more embodiments of the present disclosure, the method further comprises:
acquiring a first position information of a control object configured for the first user to select or move the first object, wherein the first position information is a coordinate information in a world coordinate system;
determining a second position information of a target virtual object corresponding to the control object in the scene based on the first position information and a preset coordinate conversion relationship;
acquiring a third position information provided at a selected object of the first object;
upon detecting that a distance between the second location information and the third location information is less than a preset distance,
determining that the first user selects the first object.

According to one or more embodiments of the present disclosure, the method further comprises:
upon determining that a gesture information of a target virtual object corresponding to the first user in the scene matches the preset gesture information, determining that the first user selects the first object.

According to one or more embodiments of the present disclosure, the method further comprises: upon determining that the first user selects the first object, display a preset gesture corresponding to the target virtual object.

According to one or more embodiments of the present disclosure, the method further comprises: when the mixed color meets a preset requirement, performing a preset instruction.

According to one or more embodiments of the present disclosure, a data processing apparatus is provided, comprising:
a display unit, configured to display a first object in a scene;
a determine unit, configured to determine that the first object triggers a second object.

The display unit is further configured to, when the determine unit determines that that the first object triggers the second object in the scene, display the second object and/or a coloring object corresponding to the second object based on a mixed color, wherein the mixed color is determined based on a color corresponding to the first object and a color corresponding to the second object.

According to one or more embodiments of the present disclosure, the apparatus is further configured to:
display the first object to be colored;
upon determining that the second object triggers the first object to be colored, display the first object to be colored based on the mixed color.

According to one or more embodiments of the present disclosure, the apparatus is further configured to:
acquire a first control parameter for a first user to control the first object;
determine, based on the first control parameter, that the first object triggers the second object in the scene.

According to one or more embodiments of the present disclosure, before determining that the first object triggers the second object in the scene, the apparatus is further configured to:
upon determining that a third object triggers the second object, determine the color corresponding to the second object based on the color corresponding to the third object, wherein the third object is a virtual object in the scene.

According to one or more embodiments of the present disclosure, the apparatus is further configured to:
acquire a second control parameter for a second user to control the third object;
determine, based on the second control parameter, that the third object triggers the second object, wherein the second control parameter is a parameter for the second user to control the third object.

According to one or more embodiments of the present disclosure, the apparatus is further configured to:
display a coloring object corresponding to the first object;
upon determining that the coloring object corresponding to the first object is in contact with the second object, determine that the first object triggers the second object in the scene.

According to one or more embodiments of the present disclosure, the apparatus is further configured to:
determine whether the first user selects the first object; and if so, perform acquiring the first control parameter for the first user to control the first object.

According to one or more embodiments of the present disclosure, the apparatus is further configured to:
acquire a first position information of a control object configured for the first user to select or move the first object, wherein the first position information is a coordinate information in a world coordinate system;
determine a second position information of a target virtual object corresponding to the control object in the scene based on the first position information and a preset coordinate conversion relationship;
acquire a third position information provided at a selected object of the first object;
upon detecting that a distance between the second location information and the third location information is less than a preset distance,
determine that the first user selects the first object.

According to one or more embodiments of the present disclosure, the apparatus is further configured to: upon determining that a gesture information of a target virtual object corresponding to the first user in the scene matches the preset gesture information, determine that the first user selects the first object.

According to one or more embodiments of the present disclosure, the apparatus is further configured to: upon determining that the first user selects the first object, display a preset gesture corresponding to the target virtual object.

According to one or more embodiments of the present disclosure, the apparatus is further configured to: when the mixed color meets a preset requirement, perform a preset instruction.

According to one or more embodiments of the present disclosure, an electronic device is provided, comprising:
a processor; and
a memory, configured to store an executable instruction for the processor,
wherein the processor is configured to perform the each of the above method by executing the executable instruction.

According to one or more embodiments of the present disclosure, a non-transitory computer readable storage medium is provided, with a computer program stored thereon, wherein when the computer program is executed by a processor, cause the processor to perform each of the above method.

The above description is only an illustration of the embodiments of the present disclosure and the technical principles applied. Those skilled in the art should understand that the scope of the disclosure involved in the present disclosure is not limited to technical solutions formed by specific combinations of the above technical features, but should also cover other technical solutions may be formed by any combination of the above technical features or their equivalent features without departing from the above disclosed concept. For example, a technical solution is formed by replacing the above-mentioned features with (but not limited to) technical features with similar functions disclosed in this disclosure.

Furthermore, although operations are depicted in a specific order, this should not be understood as requiring these operations to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological actions, it is to be understood that the subject matter defined in the appended claims is not necessarily limited to the specific features or actions described above. Rather, the specific features and actions described above are merely example forms of implementing the claims.

1. A display method, comprising:
displaying a two-dimensional thumbnail corresponding to a three-dimensional model on a human-computer interaction interface; and
in response to detecting a select operation on the two-dimensional thumbnail, displaying a display object corresponding to a selected two-dimensional thumbnail.

2. The method of claim 1, wherein the display object comprises the selected two-dimensional thumbnail and/or a sub three-dimensional model, wherein the sub three-dimensional model indicates a selected three-dimensional model, and the selected three-dimensional model corresponds to the selected two-dimensional thumbnail.

3. The method of claim 1, wherein the display object comprises the selected two-dimensional thumbnail, and
wherein displaying the display object corresponding to the selected two-dimensional thumbnail comprises:
moving the selected two-dimensional thumbnail from an original position in a predefined manner.

4. The method of claim 3, wherein moving the selected two-dimensional thumbnail from the original position in the predefined manner comprises:
moving the selected two-dimensional thumbnail from the original position along a direction indicated by a first normal vector, wherein the first normal vector is a normal vector of the human-computer interaction interface.

5. The method of claim 3, wherein:
when the selected two-dimensional thumbnail is displayed, the selected two-dimensional thumbnail is parallel to the human-computer interaction interface.

6. The method of claim 1, wherein the method further comprises:
displaying a solid frame at a display position of the selected two-dimensional thumbnail; and
displaying the display object corresponding to the selected two-dimensional thumbnail within the solid frame.

7. The method of claim 6, wherein the selected two-dimensional thumbnail is coplanar with a center of the solid frame.

8. The method of claim 6, wherein the three-dimensional model corresponds to a bounding box, and wherein the method further comprises:
based on a first shape information of the bounding box corresponding to the selected three-dimensional model, determining a second shape information of the solid frame, wherein the selected two-dimensional thumbnail corresponds to the selected three-dimensional model.

9. The method of claim 1, wherein the human-computer interaction interface is displayed in a target virtual space, wherein the target virtual space further displays a movable predefined three-dimensional object, wherein the movable predefined three-dimensional object is configured to move the selected three-dimensional model according to a move operation by a user, and
the method further comprises:
in response to detecting a select instruction for the selected two-dimensional thumbnail, displaying the selected three-dimensional model at a first end of the movable predefined three-dimensional object.

10. An electronic device, comprising:
one or more processors; and
a memory, configured to store one or more programs,
wherein, when the one or more programs are executed by the one or more processors, cause the one or more processors to:
display a two-dimensional thumbnail corresponding to a three-dimensional model on a human-computer interaction interface; and
in response to detecting a select operation on the two-dimensional thumbnail, display a display object corresponding to a selected two-dimensional thumbnail.

11. The electronic device of claim 10, wherein the display object comprises the selected two-dimensional thumbnail and/or a sub three-dimensional model, wherein the sub three-dimensional model indicates a selected three-dimensional model, and the selected three-dimensional model corresponds to the selected two-dimensional thumbnail.

12. The electronic device of claim 10, wherein the display object comprises the selected two-dimensional thumbnail, and
wherein the processor being caused to display the display object corresponding to the selected two-dimensional thumbnail comprises being caused to move the selected two-dimensional thumbnail from an original position in a predefined manner.

13. The electronic device of claim 12, wherein the processor being caused to move the selected two-dimensional thumbnail from the original position in the predefined manner comprises being caused to move the selected two-dimensional thumbnail from the original position along a direction indicated by a first normal vector, wherein the first normal vector is a normal vector of the human-computer interaction interface.

14. The electronic device of claim 12, wherein:
when the selected two-dimensional thumbnail is displayed, the selected two-dimensional thumbnail is parallel to the human-computer interaction interface.

15. The electronic device of claim 10, wherein the processor is further caused to:
display a solid frame at a display position of the selected two-dimensional thumbnail; and
display the display object corresponding to the selected two-dimensional thumbnail within the solid frame.

16. The electronic device of claim 15, wherein the selected two-dimensional thumbnail is coplanar with a center of the solid frame.

17. The electronic device of claim 15, wherein the three-dimensional model corresponds to a bounding box, and wherein the processor is further caused to:
based on a first shape information of the bounding box corresponding to the selected three-dimensional model, determine a second shape information of the solid frame, wherein the selected two-dimensional thumbnail corresponds to the selected three-dimensional model.

18. The electronic device of claim 10, wherein the human-computer interaction interface is displayed in a target virtual space, wherein the target virtual space further displays a movable predefined three-dimensional object, wherein the movable predefined three-dimensional object is configured to move the selected three-dimensional model according to a move operation by a user, and
the processor is further caused to:
in response to detecting a select instruction for the selected two-dimensional thumbnail, display the selected three-dimensional model at a first end of the movable predefined three-dimensional object.

19. A non-transitory computer readable storage medium, with a computer program stored thereon, wherein when the computer program is executed by a processor, cause the processor to:
display a two-dimensional thumbnail corresponding to a three-dimensional model on a human-computer interaction interface; and
in response to detecting a select operation on the two-dimensional thumbnail, display a display object corresponding to a selected two-dimensional thumbnail.

20. The non-transitory computer readable storage medium of claim 19, wherein the processor is further caused to:
display a solid frame at a display position of the selected two-dimensional thumbnail; and
display the display object corresponding to the selected two-dimensional thumbnail within the solid frame.
